(19) United States
(12) Patent Application Publication
(10) Pub. No.: US 2009/0061895 A1
(43) Pub. Date: Mar. 5, 2009

(54) MOBILE TERMINALS AND OPERATING METHODS THAT SHARE LOCATION INFORMATION WITH LOCATION-AWARE DEVICES

(75) Inventor: Yojak Harshad Vasa, Cary, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/850,057

(22) Filed: Sep. 5, 2007

(51) Int. Cl. H04Q 7/20

(52) U.S. Cl. 455/456.2

(57) ABSTRACT

A mobile terminal wirelessly transmits a request to provide geographic position information over an ad-hoc, short-range wireless link, in response to a user request at the mobile terminal to perform an application at the mobile terminal that uses the geographic position information. The application is then performed at the mobile terminal in response to receiving the geographic position information over the ad-hoc, short-range wireless link. The application may include a “Remember Vehicle Location” and/or “Find Return Bus Stop Location” application. Related methods and mobile terminals are also described.

### FIELD OF THE INVENTION

This invention relates to wireless communication systems and methods, and, more particularly, to mobile terminals and methods of operating same.

### BACKGROUND

Mobile terminals are widely used for obtaining access to wireless telephone services through a cellular telephone network. As the capabilities of mobile terminals increase, additional levels of user functionality are being included in the hardware and/or software of such terminals. For example, a mobile terminal may be provided with a still and/or video camera, allowing pictures and/or videos to be taken by a user and transmitted from the mobile terminal to others. Likewise, many mobile terminals include Personal Digital Assistant (PDA) type applications suitable for tracking and managing schedules, tasks and the like. Many mobile terminals also include messaging capability, such as electronic mail (e-mail), Short Message Service (SMS) and Multimedia Message Service (MMS) capabilities. Mobile terminals may also be capable of connecting to the Internet by using Internet Protocol (IP).

Mobile terminals also may be capable of wireless communications with other proximate devices using ad-hoc, short-range wireless links such as Bluetooth and/or Wi-Fi links. These ad-hoc, short-range wireless links may allow communications to a peripheral device such as a headset or to a location-aware device such as a Global Positioning System (GPS) accessory.

Mobile terminals are also increasingly being provided with the capability of determining the physical location of the terminal. For example, many mobile terminals include GPS receivers that permit the mobile terminals to determine their location with a high degree of precision. Other systems for determining the location of a mobile terminal have been implemented, including systems that obtain location information from a cellular communications network, and systems that obtain location information through inertial guidance techniques.

### SUMMARY

Mobile terminals may be operated, according to some embodiments of the present invention by wirelessly transmitting a request to provide geographic position information, also referred to herein as “location information”, from the mobile terminal over an ad-hoc, short-range wireless link in response to a user request at the mobile terminal to perform an application at the mobile terminal that uses the geographic position information. The application is then performed at the mobile terminal in response to receiving the geographic position information over the ad-hoc, short-range wireless link. Thus, in some embodiments where the mobile terminal does not include a GPS receiver or other location determination system, location based applications may still be performed, by obtaining location information from a nearby location-aware device.

In some embodiments, an indication of performance capabilities of the mobile terminal may also be wirelessly transmitting along with the request to provide geographic position information. In these embodiments, the mobile terminal can receive the geographic position information over the ad-hoc, short-range wireless link in a format that is consistent with the performance capabilities of the mobile terminal. In still other embodiments, an indication may also be transmitted by the mobile terminal that the mobile terminal is Internet enabled and the Internet may be accessed using an Internet address that is also received together with the geographic position information. In yet other embodiments, an indication may also be transmitted that the mobile terminal is capable of rendering maps and the mobile terminal may then render a map in response to receiving the geographic position information over the ad-hoc, short-range wireless link.

In other embodiments of the present invention, a request to provide geographic position information for a user's vehicle is transmitted by the mobile terminal over an ad-hoc, short-range wireless link in response to a user request at the mobile terminal to perform an application at the mobile terminal that remembers a location of the user's vehicle. A navigation system in the user's vehicle that includes an ad-hoc, short-range wireless network capability may then respond to the request. A map is displayed at the mobile terminal that indicates the location of the user's vehicle in response to receiving the geographic position information for the user's vehicle over the ad-hoc, short-range wireless link. In some embodiments, the map may be displayed in a format that is consistent with map displays in the user's vehicle. Moreover, in still other embodiments the map may be updated to indicate the location of the user's vehicle as the mobile terminal moves.

In still other embodiments, the request to provide geographic position information may be transmitted by the mobile terminal over the ad-hoc, short-range wireless link in response to a user request at the mobile terminal to perform an application at the mobile terminal that identifies a return bus stop for the user. In response to receiving geographic position information, such as a geographic position information for an arrived-at bus stop, a map is displayed at the mobile terminal that indicates the location of the return bus stop. The map may be updated to continue to indicate the location of the return bus stop as the mobile terminal moves.

Embodiments of the invention have been described above primarily in connection with methods of operating a mobile terminal. However, analogous computer program products for operating a mobile terminal may also be provided according to other embodiments of the present invention. These computer program products can comprise a computer usable storage medium having computer-readable program code embodied in the medium and configured to operate the mobile terminal as described above.

Moreover, other embodiments of the present invention can provide mobile terminals themselves. The mobile terminals may include a wireless communication module, a user interface and circuitry that is configured to cause the mobile terminal to operate as was described above. For example, circuitry may be configured to cause the mobile terminal to wirelessly transmit a request to provide geographic position information from the wireless communication module over an ad-hoc, short-range wireless link in response to a user request at the user interface to perform an application at the mobile terminal that uses the geographic position information, and to perform the application at the mobile terminal in response to receiving the geographic position information over the ad-hoc, short-range wireless link.

Embodiments of the present invention have also been described above in connection with a mobile terminal externally transmitting a request to provide geographic position information. Other embodiments of the present invention may be performed independent of whether geographic position information is obtained internally or externally by the mobile terminal. For example, methods of operating a mobile terminal according to some embodiments of the present invention store geographic position information for a user's vehicle at the mobile terminal in response to a user request at the mobile terminal to remember a location of the user's vehicle. These embodiments may display a map at the mobile terminal that indicates the location of the user's vehicle and the current location of the mobile terminal and may update the map as the current location of the mobile terminal changes. Other embodiments store geographic position information for a location of a return bus stop for a user of the mobile terminal in response to obtaining location information for an arrived-at bus stop. A map may be displayed that indicates the location of the return bus stop and a current location of the mobile terminal and the map may be updated as the current location of the mobile terminal changes.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 illustrates a mobile terminal according to some embodiments of the invention.

FIGS. 2A-2B illustrate a flip-type mobile terminal according to some embodiments of the invention.

FIG. 3 is a schematic block diagram illustrating a mobile terminal and a cellular communication system in accordance with some embodiments of the present invention.

FIG. 4 is a flowchart of operations that may be performed to operate a mobile terminal according to some embodiments of the present invention.

FIG. 5 is a flowchart of operations that may be performed to remember a vehicle location according to some embodiments of the present invention.

FIG. 6 illustrates a map that may be displayed by a mobile terminal in performing operations of FIG. 5.

FIG. 7 is a flowchart of operations that may be performed to identify a return bus stop according to some embodiments of the present invention.

FIG. 8 illustrates a map that can be displayed by a mobile terminal in performing operations of FIG. 7.

FIG. 9 is a flowchart of operations that may be performed to remember a vehicle location according to other embodiments of the present invention.

FIG. 10 is a flowchart of operations that may be performed to identify a return bus stop according to other embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element, it can be directly responsive to the other element, or intervening elements may be present. In contrast, when an element is referred to as being “directly responsive” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory) and a portable compact disc read-only memory (CD-ROM).

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

As used herein, a “mobile terminal” (or simply a “terminal”) includes, but is not limited to, a device that is configured to receive/transmit communication signals via a wireless interface with, for example, a cellular network, a wireless local area network (WLAN), a digital television network such as a DVB-H network, a satellite network, an AM/FM broadcast transmitter, and/or another communication terminal. Examples of mobile terminals include, but are not limited to, a satellite or cellular radiotelephone; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver.

Wireless communication between electronic devices may be accomplished using a wide variety of communication media, communication systems and communication standards. For example, mobile terminals such as wireless mobile telephones are typically configured to communicate via analog and/or digital wireless radio frequency (RF) telephone systems. Such devices may additionally be configured to communicate using wired and/or wireless local area networks (LANs), ad-hoc, short-range communication channels, such as Bluetooth RF communication channels and/or infrared communication channels, and/or long range communication systems, such as satellite communication systems.

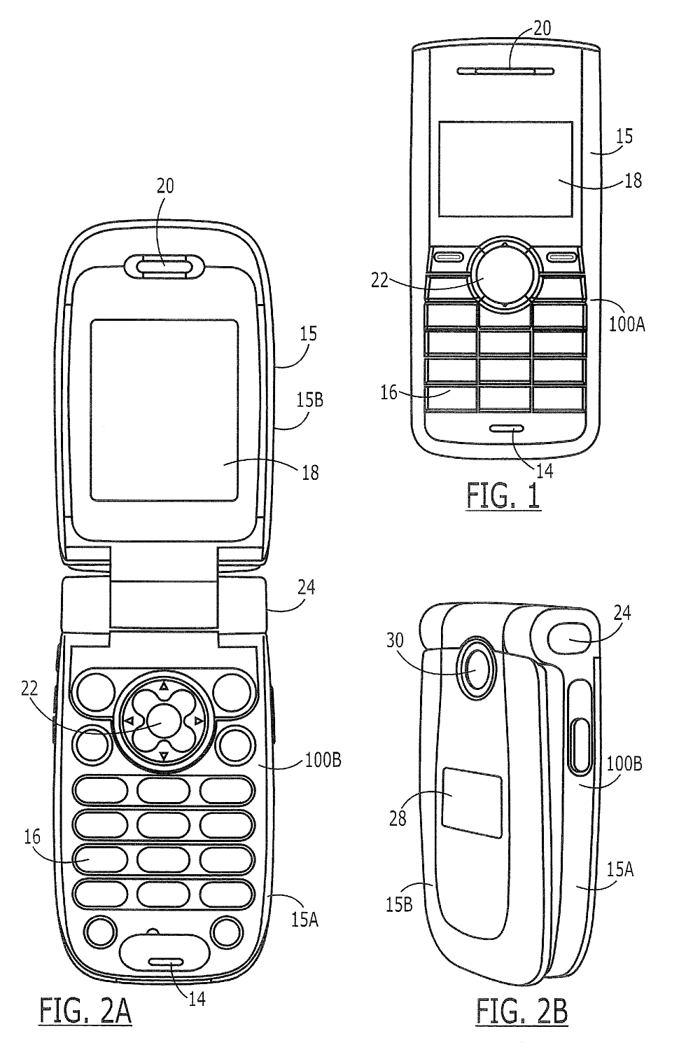

Mobile terminals, such as wireless mobile telephones, according to embodiments of the invention can have a variety of shapes, sizes and housing types. Examples of several types of mobile terminal housings are shown in FIGS. 1 to 2B. For example, a mobile terminal 100A according to some embodiments is illustrated in FIG. 1. The mobile terminal 100A includes a housing 15 that houses and protects the electronics of the mobile terminal 100A. The mobile terminal 100A includes an LCD display 18 and a keypad 16. The mobile terminal 100A further includes a multifunction control/input button 22 that can be used to select menu items and/or to input commands to the mobile terminal 100A.

The mobile terminal 100A includes a microphone port 14 and an earphone/speaker 20. The housing 15 may be designed to form an acoustic seal to the user's ear when the earphone/speaker 20 is placed against the user's head. The mobile terminal 100A may be configured to play video files and or audio files, such as song files, which may be stereophonic signals.

A flip-style mobile terminal 100B is illustrated in FIGS. 2A and 2B. The flip-style mobile terminal 100B is shown in the open position in FIG. 2A and in the closed position in FIG. 2B. The mobile terminal 100B includes a housing 15 that includes a lower housing 15A and an upper housing, or “flip” portion 15B that are rotatably connected by means of a hinge 24. The mobile terminal 100B includes a primary LCD display 18 on the inside of the flip 15B and a keypad 16 on the inside of the lower housing 15A. The mobile terminal 100B further includes a multifunction control/input button 22.

The mobile terminal 100A includes a microphone port 14 on the lower housing 1SA and an earphone/speaker 20 on the inside of the flip 15B. As shown in FIG. 2B, a secondary display 28 and a camera lens 30 may be located on the outside of the flip 15B.

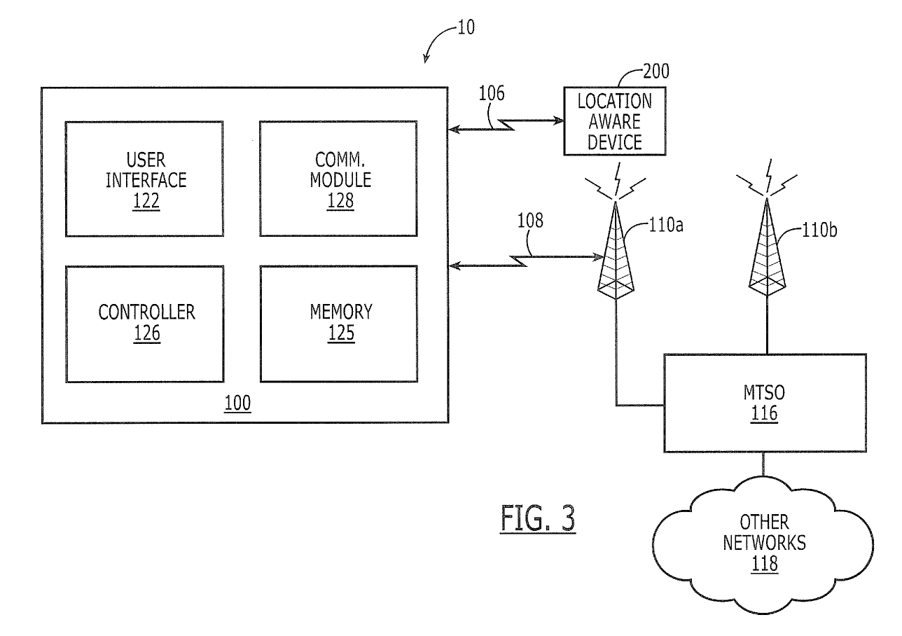

FIG. 3 is a schematic block diagram of a wireless communication system/method 10 that includes a mobile terminal 100 that is configured to operate according to various embodiments of the present invention. The mobile terminal 100 can communicate with a location-aware device 200 such as a GPS device over a ad-hoc, short-range communication link 106 such as a Bluetooth link. The mobile terminal 100 also can communicate, over another wireless communication link 108 through one or more cellular base stations 110a-b. The ad-hoc, short-range wireless communication link 106 may include an RF wireless communication link such as a Bluetooth link or an infrared communication link, such as, for example, the infrared communication link defined by the Infrared Data Association (IRDA) protocols. The IRDA defines a number of standards for infrared wireless data communication, including standards for infrared wireless communication at data rates up to 16 Mb/s.

As further illustrated in FIG. 3, the mobile terminal 100 can include a user interface 122, a controller 126, a communication module 128, and a memory 125.

The communication module 128 is configured to communicate data over one or more of the wireless links 106 and/or 108 to another remote terminal or other communication device, such as the location-aware device 200. The memory 125 is configured to store programs and or data for use by the controller 126. The memory 125 may include a nonvolatile memory that is capable of storing digital information even when power to the mobile terminal 100 is switched off.

The communication module 128 can include, for example, a cellular communication module, a Bluetooth module, an infrared communication module, and/or a WLAN module. With a cellular communication module, the mobile terminal 100 can communicate via the base stations 110a-b using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations 110a-b may be connected to a Mobile Telephone Switching Office (MTSO) 116, which, in turn, may be connected to one or more other networks 118 (e.g. the Internet, a public switched telephone network, and/or another network). With a Bluetooth or infrared module, the mobile terminal 100 can communicate via an ad-hoc network using the direct interface 106. With a WLAN module, the mobile terminal 100 can communicate through the WLAN router 114 using a communication protocol that may include, but is not limited to, 802.11a, 802.11b, 802.11e, 802.11g, and/or 802.11i.

The mobile terminal 100 may be configured to transmit and/or receive a digital data signal to/from another communication terminal that may be communicatively coupled thereto through, for example the MTSO 116, and/or another network 118, such as a public switched telephone network (PSTN). However, it will be appreciated from the foregoing description that data communication between the mobile terminal 100 and another terminal may be accomplished without using the MTSO 116 or the other networks 118.

The mobile terminal 100 may additionally include an AM/FM radio tuner, a UHF/VHF tuner, a satellite radio tuner, a DVB-H receiver, and/or another receiver configured to receive a broadcast audio/video signal and/or data signal.

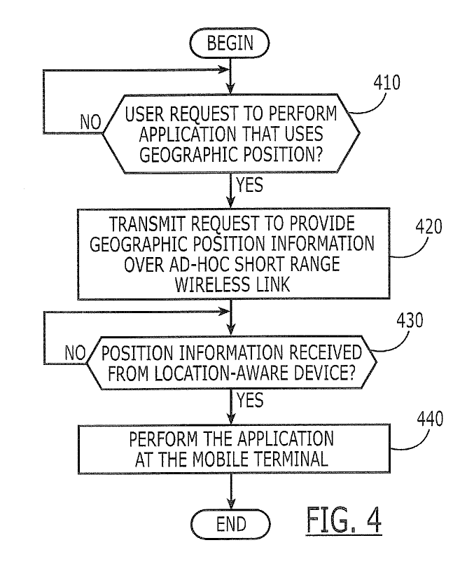

FIG. 4 is a flowchart of operations that may be performed to operate a mobile terminal, such as the mobile terminal 100 of FIGS. 1-3, according to various embodiments of the present invention. Referring now to FIG. 1 at Block 410, a user at the mobile terminal provides a request to perform an application at the mobile terminal that uses geographic position information. Various examples will be provided below. In response, at Block 420, a request to provide geographic position information is wirelessly transmitted from the mobile terminal over an ad-hoc, short-range wireless link, such as the ad-hoc, short-range wireless link 106 of FIG. 3, to a location-aware, such as the device 200 of FIG. 3. The mobile terminal then waits at Block 430 until the position information is received from the location-aware device. Upon receipt of the position information, the application is performed at the mobile terminal at Block 440. Various examples will be provided below.

Thus, according to some embodiments of the invention, a mobile terminal that does not itself include internal position determination capabilities may nonetheless perform an application that uses a geographic position, by obtaining a geographic position from external of the mobile terminal. Since the geographic position is obtained over an ad-hoc, short-range wireless link, it can be sufficiently close to the geographic position of the mobile terminal so as to allow the application to be performed using the geographic position information that was obtained externally.

Additional information may be requested by the mobile terminal at Block 420 and/or provided by the location-aware device at Block 430, according to other embodiments of the present invention, in order to perform various applications at the mobile terminal according to various embodiments of the present invention. Thus, for example, operations of Block 420 may further wirelessly transmit an indication of performance capabilities of the mobile terminal. For example, in some embodiments, an indication may be provided that the mobile terminal has color display capabilities. In other embodiments, a mobile terminal display resolution may be provided. In still other embodiments, an indication may be provided that the mobile terminal has Internet access capabilities.

Thus, for example, at Block 420 the mobile terminal may also indicate a display size and resolution so that the position information may be transmitted from the location-aware device to the mobile terminal at Block 430 in a format that is consistent with performance capabilities of the mobile terminal. For example, a map may be transmitted at Block 430 that is consistent with the resolution capabilities of the display of the mobile terminal, so that the map may be displayed effectively at the mobile terminal at Block 440.

In still other embodiments, an indication may be provided at Block 420 that the mobile terminal is Internet enabled. In response, in addition to providing the position information at Block 430, an Internet address may also be provided. The Internet address may be provided so that, for example, a map may be obtained via the Internet based on the position information that is provided at Block 430 by the location-aware device. Thus, in some embodiments, the location-aware device may only supply a location, and the rendering of a map may be provided via an Internet connection at the mobile terminal. In other embodiments, additional points of interest may be placed on a map based on the Internet address that is supplied at Block 430. For example, a location of restaurants or other points of interest may be provided using an Internet address that is supplied with the location information of Block 430.

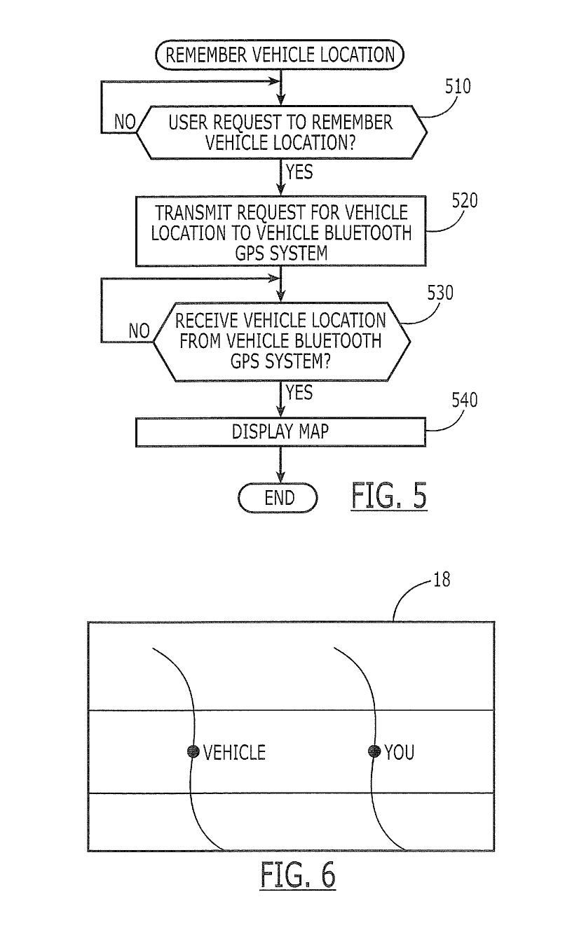

FIG. 5 is a flowchart of operations that may be performed for an application that remembers the location of the user's vehicle and may provide a specific embodiment of operations of FIG. 4. In particular, referring to FIG. 5 at Block 510, a user request is received at the mobile terminal to perform an application at the mobile terminal that remembers the location of the user's vehicle. In response, at Block 520, the mobile terminal wirelessly transmits a request for the vehicle location to the vehicle GPS system. As is well known to those having skill in the art, many vehicles now include GPS systems, often generically referred to as “navigation systems”, that may include ad-hoc, short-range communications capabilities using, for example, Bluetooth links. Some embodiments of vehicle navigation systems may be referred to herein as “Bluetooth GPS systems”.

Still referring to FIG. 5, at Block 530 the vehicle location is received from the Bluetooth GPS system of the vehicle, and at Block 540 a map is displayed at the mobile terminal that indicates the location of the user's vehicle. As was described above, in some embodiments the map may be rendered at the mobile terminal based on position information that is received from the vehicle Bluetooth GPS system. In other embodiments the map may be provided by the vehicle Bluetooth GPS system itself. In some embodiments, when the map is provided by the Bluetooth GPS system, the map may be provided for display at the mobile terminal in a format that is consistent with map displays by the navigation system in the user's vehicle. Accordingly, a seamless map presentation may be provided on the mobile terminal that is consistent with the map presentation in the vehicle navigation system.

FIG. 6 graphically illustrates a map that may be displayed on a display screen 18 of the mobile terminal that indicates the location of the vehicle (“Vehicle”) and the location of the mobile terminal (“You”). The map may be updated to indicate the current location of the vehicle as the mobile terminal moves. Updating of the map may be provided using GPS data that is obtained internally by the mobile terminal and/or externally.

Some embodiments of the invention that were described in connection with FIGS. 5 and 6 may arise from recognition that many vehicles include GPS stand-alone devices having Bluetooth capabilities as part of their navigation system. Accordingly, the location information may be sent from the stand-alone Bluetooth device to a mobile terminal. The mobile terminal therefore does not need to have its own GPS system, but may only need a map viewer so that the user can use this map on the mobile terminal to solve issues such as “where did I park my car?”. Thus, in some embodiments, when the user parks his car, the user may desire to send the location information of the car to the mobile terminal. The user may do so by selecting a menu option on the GPS device and/or the mobile terminal. The GPS device may send the coordinates to the mobile terminal and the mobile terminal may then use these coordinates to download a map from a network such as the Internet. Alternatively, the GPS device may send the map to the mobile terminal and the mobile terminal may store the map in a map viewer for later use by the user. In still other embodiments, the coordinates and/or map may be automatically sent from the GPS device to the mobile terminal when the vehicle is engaged into “park” and/or the key is removed from the vehicle's ignition so that the mobile terminal may always be aware of the location of the vehicle whether or not the user specifically enabled the vehicle location application.

The map sent by the network of the GPS device can provide different levels of support. For example, a street-level map with street information may be provided. Alternatively, a satellite image may be sent that shows an aerial photo of the vicinity. The map could also cover different geographical sizes. The location of the vehicle may be marked with a clear indicator that tells the user where they left their car.

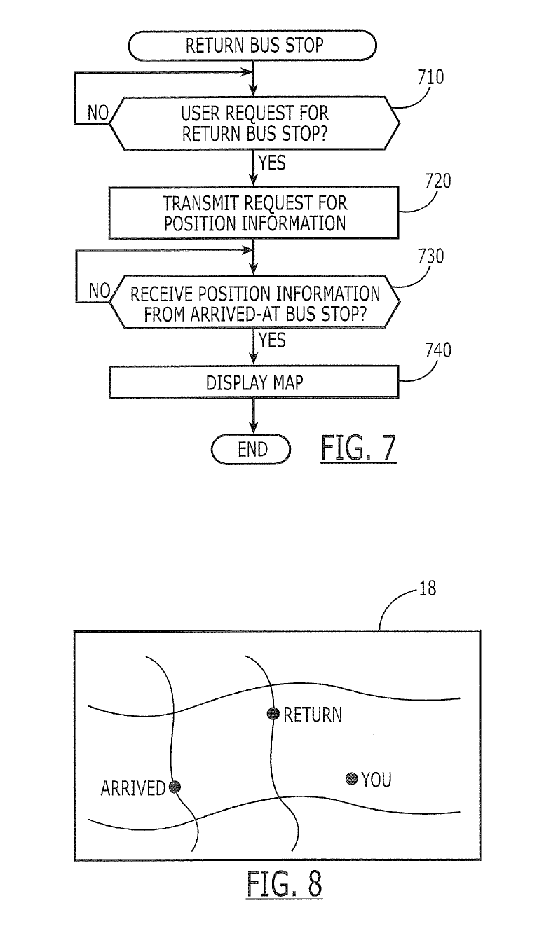

FIG. 7 is a flowchart of operations that may be performed by a mobile terminal to identify a return bus stop according to various embodiments of the present invention, which may provide another specific embodiment of operations of FIG. 4. More specifically, referring to FIG. 7 at Block 710, a mobile terminal may obtain a user request to perform an application that identifies a return bus stop for the user. The user may execute this application upon leaving a bus, so that the user can be made aware of the location of the return bus stop. At Block 720, a request for position information may be transmitted using an ad-hoc, short-range wireless link. The request for position information may be transmitted to a GPS system at the bus stop and/or a GPS system that is on the bus. At Block 730, position information may be obtained from the arrived-at bus stop. This position information may include the location of the arrived-at bus stop and the location of an Internet address where a location of the return bus stop may be obtained, in some embodiments. In other embodiments, the arrived-at bus stop may also include the location of the return bus stop as part of its response, so that a separate Internet access may not need to be performed by the mobile terminal. Finally, referring to Block 740, regardless of how the position of the return bus stop is obtained, a map may be displayed at the mobile terminal that indicates the location of the return bus stop.

FIG. 8 illustrates an example of a map which may be displayed at the mobile terminal. The map can clearly indicate the arrived-at bus stop (“Arrived”), the return bus stop (“Return”) and the current location of the mobile terminal (“You”).

Embodiments of FIGS. 7 and 8 may arise from recognition that bus stops may be enabled with a GPS beacon that users of the bus stop can download so that they can thereby remember where they got off the bus. Moreover, the return route and/or schedule can be downloaded by the user. The schedule and location of the return bus stop may be of more value to the user than the stop where the user got off.

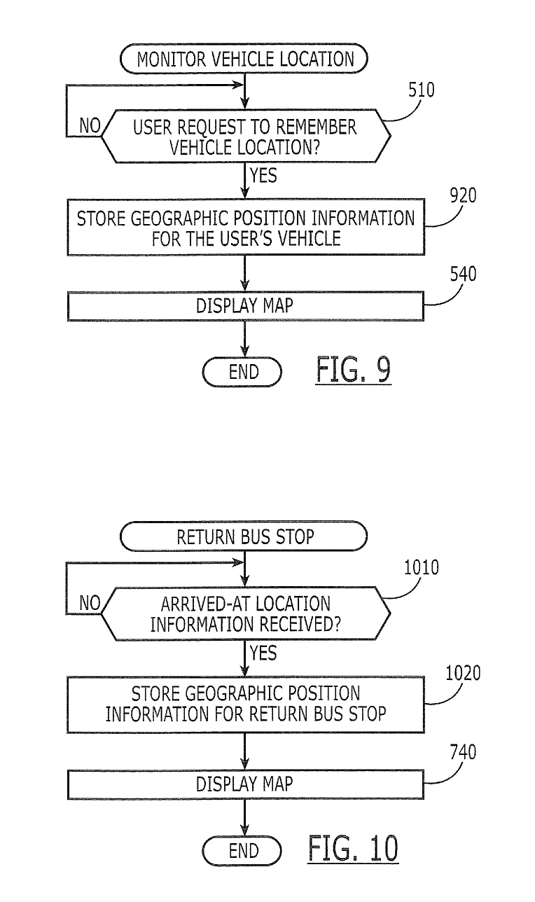

Embodiments of the invention that were described in connection with FIGS. 5-8 obtain position information from external of the mobile terminal. However, other embodiments of the present invention may remember a vehicle location and/or may obtain return bus stop information using internally generated position information as will now be described in connection with FIGS. 9 and 10.

More specifically, referring to FIG. 9, a user request may be received at Block 510 to remember the vehicle location. The user request may be generated by activating an icon menu selection, voice activation, etc. at the mobile terminal. Alternatively, the user request may be received indirectly by receiving an indication from the vehicle itself that the vehicle has been placed in park and/or the key has been removed. In response, at Block 920, geographic position information for the user's vehicle is stored at the mobile terminal. The geographic position information for the user's vehicle may correspond to a GPS location of the mobile terminal at the time the request was made and/or may be obtained from external of the mobile terminal, for example, by sending a request to the vehicle navigation system over a ad-hoc, short-range wireless link. In other embodiments, a request may be sent to the vehicle navigation system via a cellular, satellite and/or other wireless link. A map may be displayed at Block 540 automatically and/or in response to a user request to indicate the location of the user's vehicle and a current location of the mobile terminal. Moreover, as was described above the map may be updated as the current location of the mobile terminal changes.

FIG. 10 illustrates other embodiments of the present invention wherein a return bus stop information may be obtained using position information that is obtained internal to the mobile terminal and/or external of the mobile terminal. In particular, at Block 1010 location information for an arrived-at bus stop may be obtained. This location information for an arrived-at bus stop may be obtained, for example, by automatically polling a location-aware bus stop using an ad-hoc, short-range wireless link and/or by the user indicating that the current location of the mobile terminal corresponds to the location of the arrived-at bus stop. In response, at Block 1020, geographic position information is stored for the return bus stop. The geographic position information for the return bus stop may be obtained from the location-aware arrived-at bus stop and/or by accessing the Internet and/or another wireless network to obtain a corresponding return bus stop for a given route at a given arrived-at bus stop. A map may be displayed at Block 740 as was described above, that may indicate the location of the return bus stop and the current location of the mobile terminal. The map may be updated as the current location of the mobile terminal changes.

In any of the above-described embodiments, when the information is sent to the mobile terminal, the ad-hoc, short-range wireless connection may be used for simple data transfer, and any profile that is appropriate can be used. In some embodiments, the application protocol may identify the type of information being sent to the mobile terminal to ensure that an appropriate application receives the information. In other embodiments the map can be the default idle screen so that the user knows that the location information is in the mobile terminal. Once the mobile terminal is in the range of the Bluetooth enabled device, the mobile terminal may provide an indication that it is close to the location of the position of interest. Moreover, at a request from the user the location information can be deleted.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method of operating a mobile terminal comprising:
wirelessly transmitting a request to provide geographic position information from the mobile terminal over an ad-hoc, short-range wireless link in response to a user request at the mobile terminal to perform an application at the mobile terminal that uses the geographic position information; and
performing the application at the mobile terminal in response to receiving the geographic position information over the ad-hoc, short-range wireless link.

2. A method according to claim 1:
wherein wirelessly transmitting a request further comprises wirelessly transmitting an indication of performance capabilities of the mobile terminal from the mobile terminal over the ad-hoc, short-range wireless link in response to the user request at the mobile terminal to perform the application at the mobile terminal that uses the geographic position information; and
wherein performing the application comprises performing the application at the mobile terminal in response to receiving the geographic position information over the ad-hoc, short-range wireless link in a format that is consistent with the performance capabilities of the mobile terminal.

3. A method according to claim 1:
wherein wirelessly transmitting a request further comprises wirelessly transmitting an indication that the mobile terminal is Internet enabled from the mobile terminal over the ad-hoc, short-range wireless link in response to the user request at the mobile terminal to perform the application at the mobile terminal that uses the geographic position information; and
wherein performing the application comprises accessing the Internet in response to an Internet address that is received over the ad-hoc, short-range wireless link.

4. A method according to claim 1:
wherein wirelessly transmitting a request comprises wirelessly transmitting a request to provide geographic position information along with an indication that the mobile terminal is capable of rendering maps from the mobile terminal over an ad-hoc, short-range wireless link in response to a user request at the mobile terminal to perform an application at the mobile terminal that uses the geographic position information; and
wherein performing the application comprises rendering a map in response to receiving the geographic position information over the ad-hoc, short-range wireless link.

5. A method according to claim 1:
wherein wirelessly transmitting a request comprises wirelessly transmitting a request to provide geographic position information for a user's vehicle to the mobile terminal over an ad-hoc, short-range wireless link in response to a user request at the mobile terminal to perform an application at the mobile terminal that remembers a location of the user's vehicle; and
wherein performing the application comprises displaying a map at the mobile terminal that indicates the location of the user's vehicle in response to receiving the geographic position information for the user's vehicle over the ad-hoc, short-range wireless link.

6. A method according to claim 5 wherein displaying a map comprises displaying a map at the mobile terminal in a format that is consistent with map displays in the user's vehicle.

7. A method according to claim 5 wherein displaying a map is followed by updating the map to indicate the location of the user's vehicle as the mobile terminal moves.

8. A method according to claim 1:
wherein wirelessly transmitting a request comprises wirelessly transmitting a request to provide geographic position information over an ad-hoc, short-range wireless link in response to a user request at the mobile terminal to perform an application at the mobile terminal that identifies a return bus stop for the user; and
wherein performing the application comprises displaying a map that indicates a location of the return bus stop at the mobile terminal in response to receiving the geographic position information over the ad-hoc, short-range wireless link.

9. A method according to claim 8 wherein wirelessly transmitting a request to provide geographic position information over an ad-hoc, short-range wireless link comprises wirelessly transmitting a request to provide geographic position information for an arrived-at bus stop over an ad-hoc, short-range wireless link.

10. A computer program product the comprising a computer usable storage medium having computer-readable program code embodied in the medium, the computer-readable program code configured to operate the mobile terminal according to claim 1.

11. A mobile terminal comprising:
a wireless communication module;
a user interface; and
circuitry configured to cause the mobile terminal to wirelessly transmit a request to provide geographic position information from the wireless communication module over an ad-hoc, short-range wireless link in response to a user request at the user interface to perform an application at the mobile terminal that uses the geographic position information, and to perform the application at the mobile terminal in response to receiving the geographic position information over the ad-hoc, short-range wireless link.

12. A mobile terminal according to claim 11 wherein the circuitry is further configured to wirelessly transmit an indication of performance capabilities of the mobile terminal and to perform the application in response to receiving the geographic position information over the ad-hoc, short-range wireless link in a format that is consistent with the performance capabilities of the mobile terminal.

13. A mobile terminal according to claim 11 wherein the circuitry is further configured to wirelessly transmit an indication that the mobile terminal is Internet enabled and to access the Internet in response to an Internet address that is received over the ad-hoc, short-range wireless link.

14. A mobile terminal according to claim 11 wherein the circuitry is further configured to wirelessly transmit an indication that the mobile terminal is capable of rendering maps and to render a map in response to receiving the geographic position information over the ad-hoc, short-range wireless link.

15. A mobile terminal according to claim 11 wherein the circuitry is further configured to wirelessly transmit a request to provide geographic position information for a user's vehicle to the mobile terminal over an ad-hoc, short-range wireless link in response to a user request at the mobile terminal to perform an application at the mobile terminal that remembers a location of the user's vehicle, and to display a map at the mobile terminal that indicates the location of the user's vehicle in response to receiving the geographic position information for the user's vehicle over the ad-hoc, short-range wireless link.

16. A mobile terminal according to claim 11 wherein the circuitry is further configured to wirelessly transmit a request to provide geographic position information over an ad-hoc, short-range wireless link in response to a user request at the mobile terminal to perform an application at the mobile terminal that identifies a return bus stop for the user, and to display a map that indicates a location of the return bus stop at the mobile terminal in response to receiving the geographic position information over the ad-hoc, short-range wireless link.

17. A method of operating a mobile terminal comprising:
storing geographic position information for a user's vehicle at the mobile terminal in response to a user request at the mobile terminal to remember a location of the user's vehicle.

18. A method according to claim 17 further comprising:
displaying a map at the mobile terminal that indicates the location of the user's vehicle and a current location of the mobile terminal.

19. A method according to claim 18 further comprising:
updating the map as the current location of the mobile terminal changes.

20. A mobile terminal configured to perform the method of claim 17.

21. A method of operating a mobile terminal comprising:
storing geographic position information for a location of a return bus stop for a user of the mobile terminal in response to obtaining location information for an arrived-at bus stop.

22. A method according to claim 21 further comprising:
displaying a map at the mobile terminal that indicates the location of the return bus stop and a current location of the mobile terminal.

23. A method according to claim 22 further comprising:
updating the map as the current location of the mobile terminal changes.

24. A mobile terminal configured to perform the method of claim 21.
